(19) United States
(12) Patent Application Publication
(10) Pub. No.: US 2018/0055061 A1
(43) Pub. Date: Mar. 1, 2018

(54) DOUGH MIXER WITH WEIGHING FUNCTION

(71) Applicant: Housoen Electric Manufacture Co., Ltd., Jiangmen City (CN)

(72) Inventor: Yao Tian Deng, Jiangmen City (CN)

(21) Appl. No.: 15/353,908

(22) Filed: Nov. 17, 2016

(30) Foreign Application Priority Data
Aug. 29, 2016 (CN) 201610761047.9

(51) Int. Cl. A21C 1/14; A21C 1/02; B01F 15/00

(52) U.S. Cl. CPC A21C 1/146; A21C 1/02; B01F 2215/0011; B01F 15/00194; A21C 1/1405

(57) ABSTRACT

A dough mixer with a weighing function includes a main machine and a dough mixing assembly mounted on the main machine, wherein the main machine comprises a motor therein and the dough mixing assembly comprises a dough mixing bowl, an upper cover, a transmission shaft connected to the motor and a dough mixing device connected to the transmission shaft. The dough mixer also includes two symmetrically arranged weighing sensors at left and right sides of the main machine respectively. With the dough mixer, ingredients can be directly placed into the dough mixing bowl and weighed, so that the operation of the dough mixer is simple and rapid.

### CROSS-REFERENCE TO RELATED APPLICATION

This application claims priority to and the benefit of Chinese Patent Application Serial No. 201610761047.9, filed on Aug. 29, 2016, the entire disclosure of which is hereby incorporated by reference.

### TECHNICAL FIELD

This disclosure relates to a dough mixer with a weighing function.

### BACKGROUND

Dough mixers are corollary equipment for pasta processing. In use of a dough mixer, dry flour is poured in a dough mixing bowl of the dough mixer, followed by a right amount of water, and then a dough mixing mechanism in the dough mixer drives a dough mixing device via a rotating shaft to rotate, such that the dry flour is mixed with the water into a dough and the dough is kneaded. In addition, a user usually adds eggs into the dough during dough kneading for making bread. In order to obtain a proper proportion, the user generally needs to weight a defined amount of ingredients, such as flour, water, sugar, eggs and the like, by an electronic scale before adding them into the dough mixing bowl. Such an operation is tedious, time- consumed and inefficient.

### SUMMARY

In order to overcome the defects of the prior art, a dough mixer with a weighing function is provided. With such a dough mixer, users can directly add the ingredients into the dough mixing bowl and weight them therein. Its operation is simple, rapid and convenient.

A technical solution adopted by the disclosure to solve its technical problem can be described as follows.

The dough mixer with a weighing function comprises a main machine comprising a motor arranged therein and a dough mixing assembly mounted on the main machine. The dough mixing assembly comprises a dough mixing bowl, a transmission shaft connected to the motor, a dough mixing device connected to the transmission shaft, an upper cover. The dough mixer further comprise a weighing sensor arranged at each of left and right sides of the main machine, wherein the two weighing sensors are symmetrically arranged.

As an improvement of the technical solution, the weighing sensors are connected with a storage.

As an improvement of the technical solution, the main machine comprises a panel for supporting the dough mixing assembly, and brackets connected with a bottom surface of the panel and fixedly connected with the weighing sensors.

As an improvement of the technical solution, the panel is provided with connection pillars arranged on a bottom surface thereof, the brackets are provided with cylinders arranged thereon and matched with the connection pillars, wherein the connection pillars are divided into two groups, each consisting of four connection pillars.

As an improvement of the technical solution, the dough mixer further comprises two bearing legs respectively arranged at each of left and right sides of the main machine, and a cross bar arranged between two bearing legs at the same side and fixedly connected with one of the weighing sensors.

As an improvement of the technical solution, the dough mixer further comprises a detachable scraper device connected to an upper end of the dough mixing device, wherein the scraper device comprises two bowl wall scrapers oppositely arranged for scraping off materials adhered on an inner wall of the dough mixing bowl, and a center scraper for scraping off materials adhered on an outer wall of the transmission shaft, wherein the bowl wall scrapers are provided with blades fitting the inner wall of the dough mixing bowl, and the center scraper is provided with a blade matched with the outer wall of the transmission shaft in shape.

As an improvement of the technical solution, the bowl wall scrapers and the center scraper are made of a silica gel material.

As an improvement of the technical solution, the scraper device comprises a top bracket mounted on the dough mixing device, wherein the center scraper is fixedly connected to an outer wall of the top bracket, and the top bracket is provided with a supporting arm arranged at either side thereof and fixedly connected with the top bracket by screws for mounting one of the bowl wall scrapers.

As an improvement of the technical solution, the top bracket on the outer wall thereof and the supporting arms at end portions thereof are provided with mounting sleeves arranged, and the bowl wall scrapers and the center scraper are provided with elastic buckles matched with the mounting sleeves.

As an improvement of the technical solution, the top bracket is of a bowl shape and provided with buckles, through which the top bracket is buckled on the dough mixing device.

The present disclosure has the beneficial effects that: weights of the ingredients added into the dough mixing bowl are weighed immediately by the weighing sensors arranged at both the left and right sides of the main machine, thereby eliminating/reducing the tedious operation of weighing materials one by one by an electronic scale when an existing dough mixer is in use; and symmetric arrangement of two weighing sensors ensures that the ingredients can be accurately weighed no matter where the ingredients are placed in the dough mixing bowl in the weighing process, so that the dough mixer is not limited to the position and is more convenient to use. The dough mixer is reasonable and practical in structure, is practical and convenient, and is accurate and reliable to weigh.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of an embodiment of a dough mixer according to implementations of this disclosure.

FIG. 2 is a bottom perspective view of the embodiment of FIG. 1 with a main housing cover removed.

FIG. 3 is a side view of a connection part of a weighing sensor according to implementations of this disclosure.

FIG. 4 is an exploded view of a dough mixer according to implementations of this disclosure.

FIG. 5 is an exploded view of a scraper device according to implementations of this disclosure.

### DETAILED DESCRIPTION

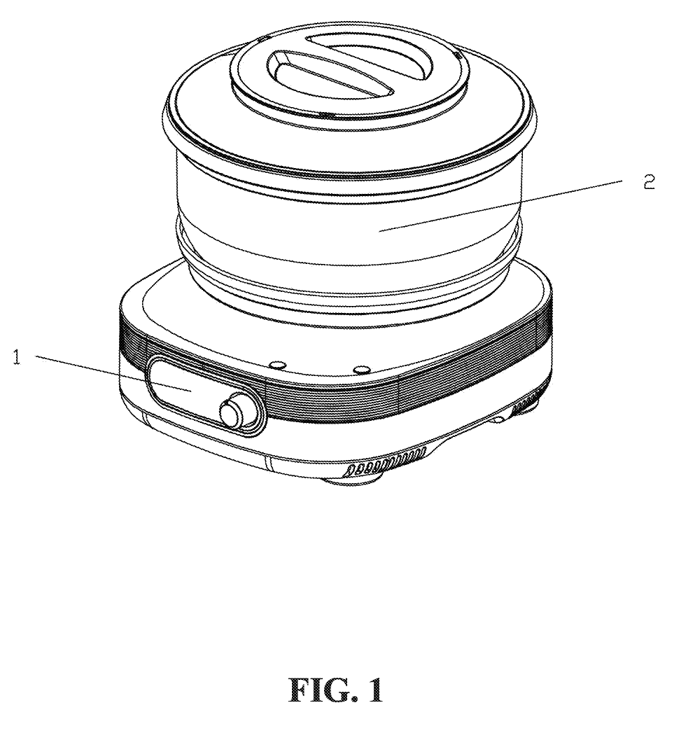

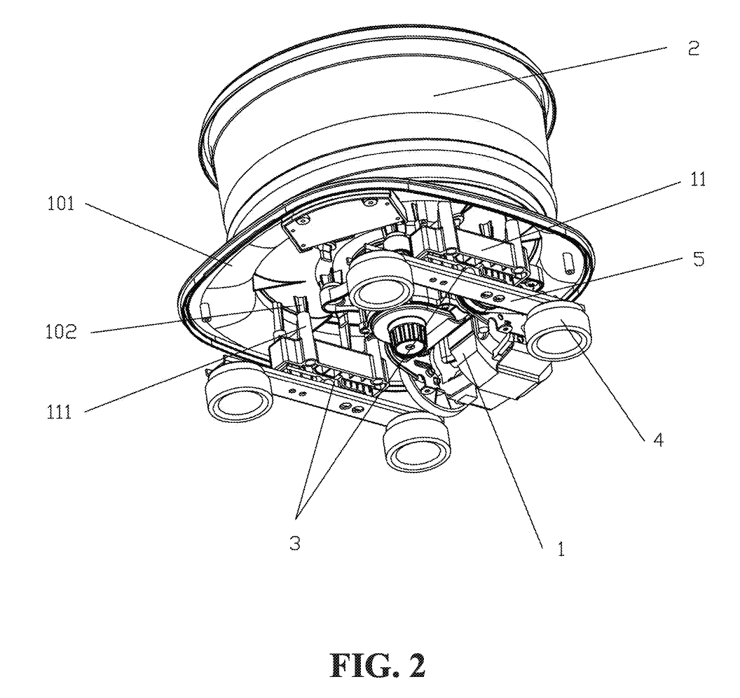

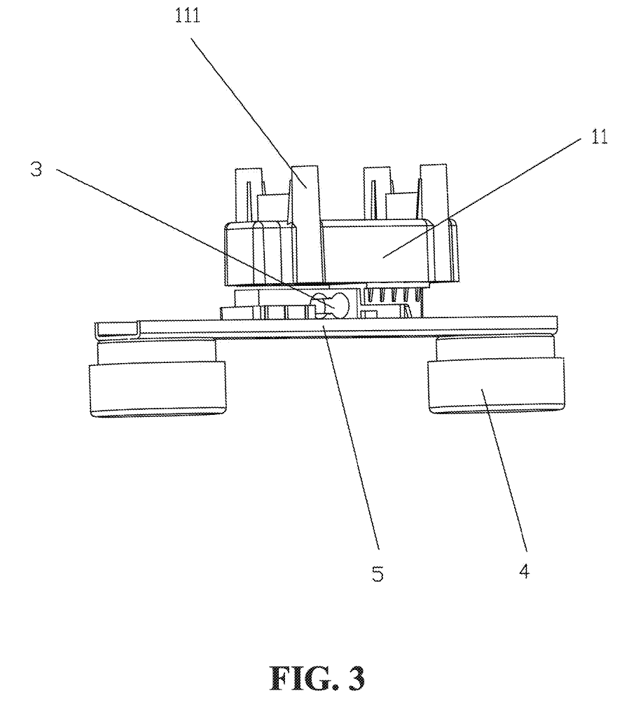

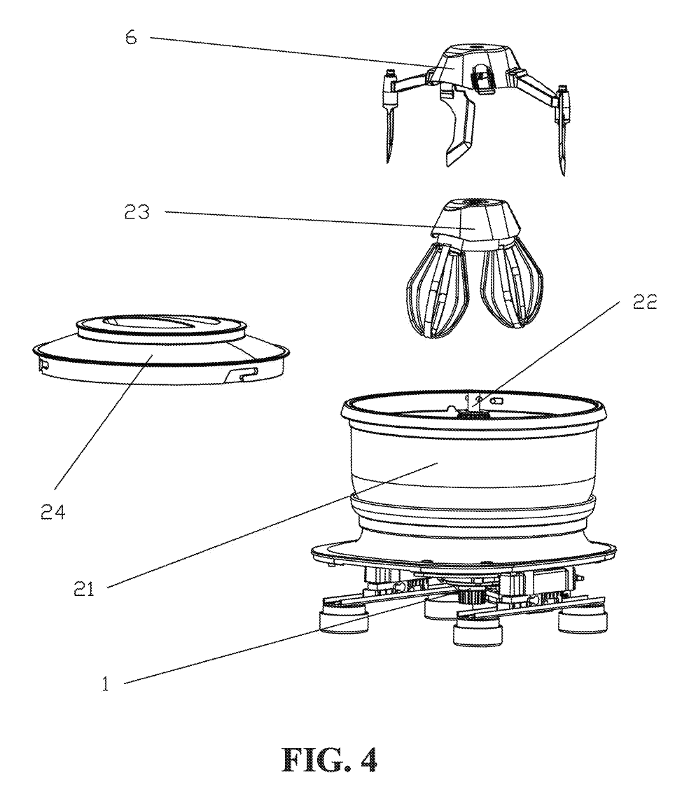

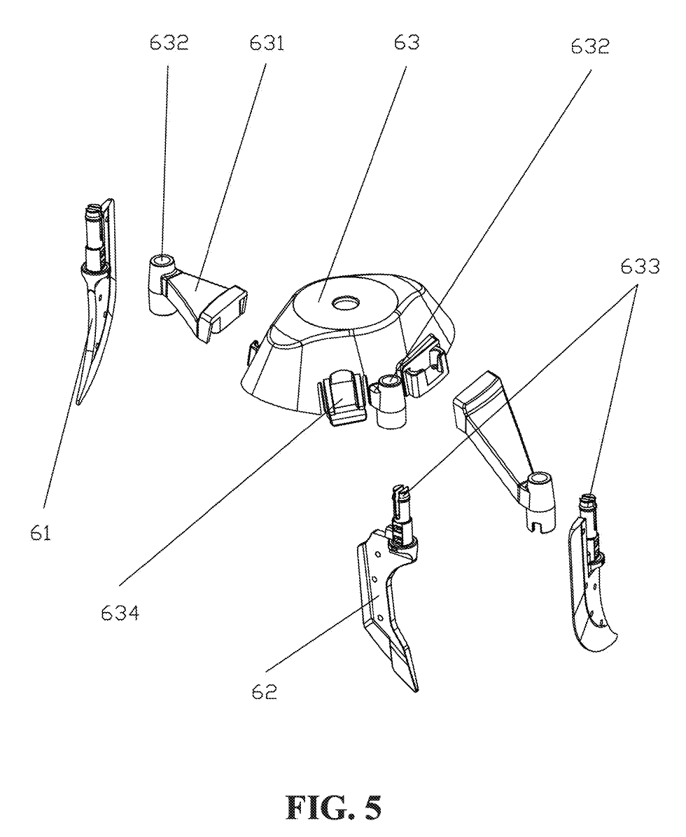

As shown in FIGS. 1 to 5, a dough mixer with a weighing function comprises a main machine 1 provided with a motor, and a dough mixing assembly 2 mounted on the main machine 1. The dough mixing assembly 2 comprises a dough mixing bowl 21, a transmission shaft 22, an upper cover 24, and a dough mixing device 23. The transmission shaft 22 is arranged in the dough mixing bowl 21 for connecting the motor and the dough mixing device 23. The dough mixer further comprises two weighing sensors symmetrically arranged, i.e. respectively at left and right sides of the main machine 1. The main machine 1 comprises a display screen positioned on an outer wall thereof and connected with the weighing sensors 3, a start-stop button arranged thereon for controlling the motor to start/stop, and a bilateral switch connected to the start-stop button for controlling the start/stop of the motor and the weighing sensors 3 respectively. The bilateral switch is configured such that, the weighing sensors 3 are turned off when the motor is turned on, and when the weighing sensors 3 are turned on when the motor is tuned of. Preferably, the weighing sensors 3 are connected with a storage for storing weighing data, such that the weighing data obtained from multiple measures is accumulated. With such an arrangement, weights of materials added into the dough mixing bowl 21 can be accurately measured by the weighing sensors 3 symmetrically arranged at the left and right sides of the main machine 1. Moreover, the two weighing sensors 3, which are symmetrically arranged at both sides of the main machine 1, would not be influenced by position of the materials, i.e. the materials can be accurately weighed no matter where the materials are positioned in the dough mixing bowl 21. Resulting from above, the dough mixer is featured by easy use, as it eliminates the tedious operation of weighing materials one by one on an electronic scale.

In the implementation, preferably, the main machine 1 comprises a panel 101 for supporting the dough mixing assembly 2, and brackets 11 arranged on a bottom surface of the panel 101 for fixing the weighing sensors 3. Preferably, the panel 101 are provided with connection pillars 102 arranged on a bottom surface thereof, and accordingly the brackets 11 are provided thereon with cylinders 111 matched with the connection pillars 102. The connection pillars 102 are arranged in two groups, and each of the groups includes four connection pillars 102. With such an arrangement, by means of the connection pillars 102 and the cylinders 111 matched, the brackets 11 can directly pass weight carried by the panel 101 to the weighing sensors 3, thereby avoiding errors and ensuring weighing accuracy.

In the implementation, preferably, the dough mixer further comprises two bearing legs 4 arranged at each of left and right sides of the main machine 1, and a cross bar 5 arranged between two bearing legs 4 at the same side, and on which one of the weighing sensors 3 is fixedly connected. Four counter weight legs take effects of stable weighing and small error, and improve operation accuracy.

In the implementation, preferably, the dough mixer further comprises a detachable scraper device 6 connected with an upper end of the dough mixing device 23. The scraper device 6 comprises two bowl wall scrapers 61 oppositely arranged for scraping off materials adhered on an inner wall of the dough mixing bowl 21, and a center scraper 62 for scraping off materials adhered on an outer wall of the transmission shaft 22. Specifically, the bowl wall scrapers 61 are provided with blades fitting the inner wall of the dough mixing bowl 21, and the center scraper 62 is provided with a blade matched with the outer wall of the transmission shaft 22 in shape. Preferably, the bowl wall scrapers 61 and the center scraper 62 are made of a silica gel material. Due to elasticity of the silica gel material, the blades of the bowl wall scrapers 61 and the center scraper 62 are hold closely on the inner wall of the dough mixing bowl 21 and the outer wall of the transmission shaft 22, respectively. As the scraper device 6 is mounted at the upper end of the dough mixing device 23 and rotates with the dough mixing device 23, the bowl wall scrapers 61 and the center scraper 62 can scrap off doughs adhered on the inner wall of the dough mixing bowl 21 and the outer wall of the transmission shaft 22. The doughs fall into the dough mixing bowl 21 and are mixed with a large dough, thereby avoiding waste and improving the utilization rate of flour. In addition, after used, the inner wall of the dough mixing bowl 21 and the outer wall of the transmission shaft 22 are relatively clean, bringing conveniences in cleaning to users.

In the implementation, preferably, the scraper device 6 comprises a top bracket 63 mounted on the dough mixing device 23, and the center scraper 62 is fixedly connected to an outer wall of the top bracket 63. The top bracket 63 is provided a supporting arm 631 arranged at each of two opposing sides thereof for mounting one of the corresponding bowl wall scrapers 61, wherein the supporting arm 631 is fixedly connected to the top bracket 63 by screws. Preferably, the top bracket 63 at an outer wall thereof and the supporting arms 631 at end portions thereof are provided with mounting sleeves 632, and the bowl wall scrapers 61 and the center scraper 62 are provided with elastic buckles 633 matched with the mounting sleeves 632. Preferably, the top bracket 63 is of a bowl shape and is buckled on the dough mixing device 23. The top bracket 63 is further provided with buckles 634 for buckling with the dough mixing device 23. With such a structure, for the dough mixing bowls 21 of different sizes, the supporting arms 631 and bowl wall scrapers 61 of different specifications can be replaced. Due to universality, the bowl wall scrapers 61 and the center scraper 62 are mounted on the mounting sleeves 632 by the elastic buckles 633. Therefore, the dough mixer of the disclosure is simple in structure, easy to assemble, disassemble and maintain. The bowl-shaped top bracket 63 is buckled on the dough mixing device 23 and is locked by the buckles 634, thereby ensuring a stable and reliable connection between the scraper device 6 and the dough mixing device 23 during the dough mixing process, as well as facilitating disassembling and cleaning the scraper device 6.

Optional implementations of the present disclosure can also be said to broadly consist in the parts, elements and features referred to or indicated herein, individually or collectively, in any or all combinations of two or more of the parts, elements or features, and wherein specific integers are mentioned herein which have known equivalents in the art to which the disclosure relates, such known equivalents are deemed to be incorporated herein as if individually set forth.

Although a preferred implementation haves been described in detail, it should be understood that various changes, substitutions, and alterations can be made by one of ordinary skill in the art without departing from the scope of the present disclosure. It will be appreciated that various forms of the disclosure can be used individually or in combination.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A dough mixer with a weighing function, comprising:
a main machine comprising a motor arranged therein; and
a dough mixing assembly mounted on the main machine, comprising:
a dough mixing bowl;
a transmission shaft connected to the motor;
a dough mixing device connected to the transmission shaft;
an upper cover; and
a first weighing sensor and a second weighing sensor arranged at a first side and a second side, respectively, of the main machine, wherein the first weighing sensor and the second weighing sensor are symmetrically arranged.

2. The dough mixer of claim 1, wherein the first weighing sensor and the second weighing sensor are connected with a storage.

3. The dough mixer of claim 2, wherein the main machine comprises:
a panel for supporting the dough mixing assembly; and
brackets connected with a bottom surface of the panel and fixedly connected with the first weighing sensor and the second weighing sensor.

4. The dough mixer of claim 3, wherein the panel comprises connection pillars arranged on a bottom surface of the panel, and the brackets comprise cylinders arranged on the brackets and matched with the connection pillars, wherein the connection pillars are arranged in two groups, each of the two groups consisting of four connection pillars.

5. The dough mixer of claim 4, further comprising:
a first pair of bearing legs arranged at the first side of the main machine, wherein a first cross bar is arranged between the first pair of bearing legs and fixedly connected with the first weighing sensor; and
a second pair of bearing legs arranged at the second side of the main machine, wherein a second cross bar is arranged between the second pair of bearing legs and fixedly connected with the second weighing sensor.

6. The dough mixer of claim 1, further comprising a scraper device, wherein the scraper device is detachably connected to an upper end of the dough mixing device and comprises:
a first bowl wall scraper, comprising a first blade fitting an inner wall of the dough mixing bowl;
a second bowl wall scraper, comprising a second blade fitting the inner wall of the dough mixing bowl, wherein the second bow wall scraper is arranged opposite to the first bowl wall scraper; and
a center scraper, comprising a third blade matched with an outer wall of the transmission shaft in shape.

7. The dough mixer of claim 6, wherein the first bowl wall scraper, the second bowl wall scraper, and the center scraper are made of a silica gel material.

8. The dough mixer of claim 7, wherein the scraper device comprises:
a top bracket, mounted on the dough mixing device, wherein the center scraper is fixedly connected to an outer wall of the top bracket;
a first supporting arm, arranged at a first side of the top bracket; and
a second supporting arm arranged at a second side of the top bracket, wherein the first supporting arm and the second supporting arm are fixedly connected with the top bracket by screws.

9. The dough mixer of claim 8, wherein
the first supporting arm comprises a first mounting sleeve at a first end portion, the first bowl wall scraper comprising a first elastic buckle to be matched with the first mounting sleeve,
the second supporting arm comprises a second mounting sleeve at a second end portion, the second bowl wall scraper comprising a second elastic buckle to be matched with the second mounting sleeve, and
the top bracket comprises a third mounting sleeve on the outer wall of the top bracket, the center scraper comprising a third elastic buckle to be matched with the third mounting sleeve.

10. The dough mixer of claim 8, wherein the top bracket comprises buckles on the outer wall of the top bracket, the top bracket being of a bowl shape and buckled on the dough mixing device through the buckles.
